(19) United States
(12) Patent Application Publication
(10) Pub. No.: US 2003/0220009 A1
(43) Pub. Date: Nov. 27, 2003

(54) Electronic apparatus comprising guide section that guides plug to connector

(75) Inventors: Koichiro Takeguchi, Hachioji-shi (JP); Masataka Tokoro, Tachikawa-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/419,103

(22) Filed: Apr. 21, 2003

(30) Foreign Application Priority Data
May 27, 2002 (JP) 2002-152572

(51) Int. Cl. H01R 13/64

(52) U.S. Cl. 439/374

(57) ABSTRACT

Electronic apparatus is provided with a housing including a peripheral wall having an opening section into which a plug is inserted, and a connector received in the housing, opposed to the opening section and enabling detachable connection to the plug. The peripheral wall of the housing includes a guide section configured to guide the plug to the opening section.

### CROSS-REFERENCE TO RELATED APPLICATIONS

This application is based upon and claims the benefit of priority from the prior Japanese Patent Application No. 2002-152572, filed May 27, 2002, the entire contents of which are incorporated herein by reference.

### BACKGROUND OF THE INVENTION

1. Field of the Invention

The present invention relates to an electronic apparatus (e.g., a portable computer), and more particularly to a structure for guiding a plug to a connector received inside the housing of the electronic apparatus.

2. Description of the Related Art

A notebook-type portable computer comprises a computer main body including a keyboard, and also comprises a display unit supported on the computer main body. The computer main body has a flat box-shaped housing. The housing has a peripheral wall provided with opening sections, and houses a printed circuit board. A plurality of connectors, such as a USB connector and a LAN connector, are mounted on the printed circuit board. The connectors are exposed to the outside of the housing through the opening sections described above. Peripheral equipment, which is coupled to the connector when it is used, is provided with a connection cable. The connection cable has a plug at an end, and the plug is attached to the connector through the opening section of the housing. In this state, the peripheral equipment is electrically connected to the portable computer.

In many cases, one portable computer is carried and used by an indefinite number of persons. For example, it may be used at a location away from office for the exchange of data, or on the customer's premises for presentation. In recent years, therefore, the security of the data stored in the portable computer has become a matter of concern, and the portable computers recently developed include a computer which cannot be started without inserting a security key into a connector.

When a portable computer is carried, the plug of a connection cable has to be detached from the connector of the computer. In addition, a security key has to be inserted each time the portable computer is used. As can be seen from this, plugs are inserted or removed from connectors more frequently in the case of the portable computer than in the case of a desktop computer.

In the conventional portable computer, the connector is merely exposed to the outside of the housing through the opening section. That is to say, the conventional portable computer does not have a guide section for guiding the plug to the connector. Where the opening section is defined in the rear wall of the housing, the operator has to lean forward and confirm the position of the opening section with his or her eyes each time the plug should be attached to the connector. Hence, the connection of the plug to the connector is not easy, resulting in poor work efficiency.

### BRIEF SUMMARY OF THE INVENTION

According to an embodiment of the present invention, an electronic apparatus comprises: a housing including a peripheral wall having an opening section into which a plug is inserted; and a connector received in the housing, opposed to the opening section and enabling detachable connection to the plug. The peripheral wall has a guide section configured to guide the plug to the opening section.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view of a portable computer according to one embodiment of the present invention.

FIG. 2 is a perspective view showing a state where a USB cable is connected to the computer main body in the embodiment.

FIG. 3 is a perspective view of the portable computer and shows the rear wall of the housing, with USB connectors in the exposed state.

FIG. 4 is a perspective view showing how the positional relationship between the insertion port of a USB connector and the third opening section of the housing is in the embodiment of the present invention.

FIG. 5 is a perspective view of the portable computer and shows how the positional relationship between the insertion port of a LAN connector and the fourth opening section of the housing is in the embodiment of the present invention.

FIG. 6 is a sectional view of the portable computer and shows how the positional relationship between the insertion port of the USB connector and the third opening section of the housing is in the embodiment of the present invention.

FIG. 7A is a sectional view of the portable computer and shows a state where a plug is pushed against the guide surface of a first guide section in the embodiment of the present invention.

FIG. 7B is a sectional view of the portable computer and shows a state where the connection between the plug and the USB connector has just been completed in the embodiment of the present invention.

FIG. 8 is a plan view of the portable computer and shows how the positional relationships among the introducing ports of the first and second guide sections and marks are in the embodiment of the present invention.

FIG. 9 is a perspective view of the portable computer and shows how the positional relationships among the display unit and the introducing ports of the first and second guide sections are in the embodiment of the present invention when the display unit has been rotated to the open position.

### DETAILED DESCRIPTION OF THE INVENTION

A portable computer according to one embodiment of the present invention will now be described with reference to the accompanying drawings.

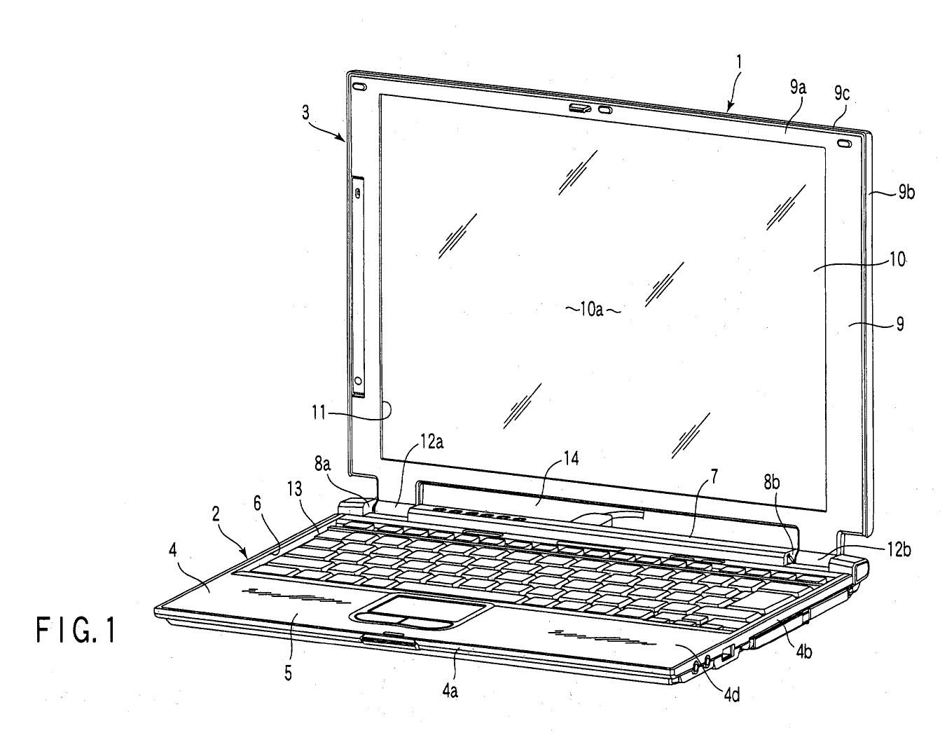

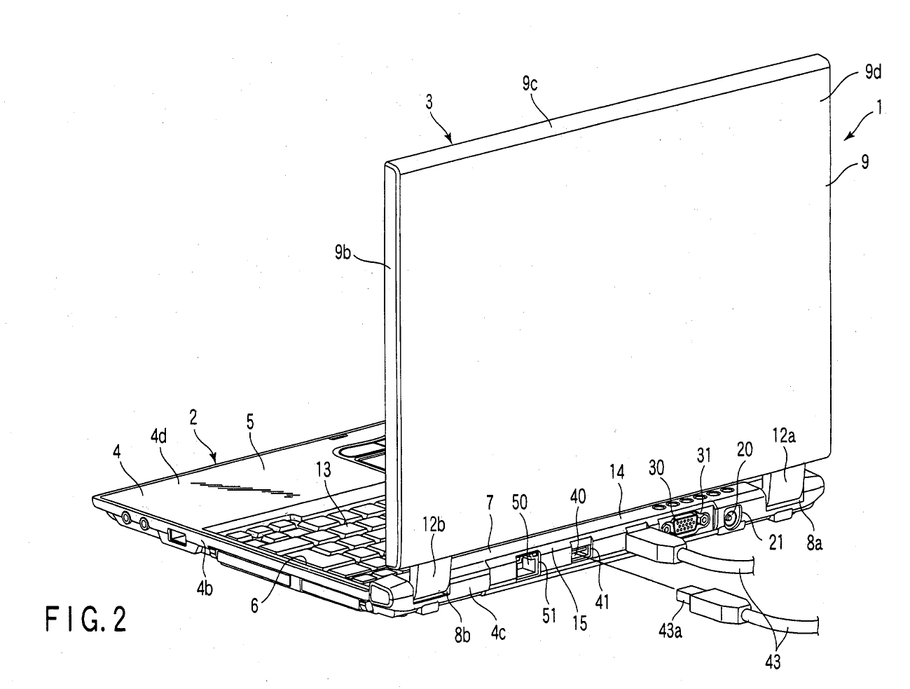

FIGS. 1 and 2 show a notebook-type portable computer 1, which is one type of electronic apparatus. The portable computer 1 comprises a computer main body 2 and a display unit 3 supported on the computer main body 2.

The computer main body 2 includes a housing 4 placed on top of a desk. The housing 4 is flat and box-shaped, and includes a front wall 4a, right and left side walls 4b, a rear wall 4c, a top wall 4d and a bottom wall 4e. In the present embodiment, the rear wall 4c is a peripheral wall of the housing 4.

The upper wall 4d of the housing 4 includes a palm rest 5 and a keyboard attachment portion 6. The palm rest 5 is a front part of the upper wall 4d and extends in the widthwise direction of the housing 4. The keyboard attachment portion 6 is behind the palm rest 5 and supports a keyboard 13.

The rear portion of the upper wall 4d is a projected portion 7. The projected portion 7 is located behind the keyboard 13 and extends in the widthwise direction of the housing 4. The rear edge of the projected portion 7 is continuous with the upper edge portion of the rear wall 4c of the housing 4. The projected portion 7 includes a pair of display supports 8a and 8b. The display supports 8a and 8b are hollow sections and spaced from each other in the widthwise direction of the housing 4.

The display unit 3 is provided with a display housing 9 and a liquid crystal display panel 10 fitted in the display housing 9. The display housing 9 is flat and box-shaped, and includes a front surface 9a, right and left side surfaces 9b, an upper surface 9c and a rear surface 9d. The liquid crystal display panel 10 has a display screen 10a. The display screen 10a is fitted in a depressed section 11 defined in the front surface 9a of the display housing 9 and is exposed to the outside of the display housing 9.

The display housing 9 has a pair of legs 12a and 12b. The legs 12a and 12b are spaced in the widthwise direction of the display housing 9 and arranged inside the display supports 8a and 8b of the housing 4. The legs 12a and 12b are rotatably coupled to the rear portion of the housing 4 by means of hinges (not shown). With this structure, the display unit 3 is rotatable between two positions, namely, a closed position where the display unit 3 lies and covers the palm rest 5 and the keyboard 13 from above, and an open position where it stands and permits the palm rest 5 and the keyboard 13 to be in an exposed state. As shown in FIGS. 1 and 9, when the display unit 3 is rotated to the open position, a gap 14 is defined between the lower portion of the display housing 9 and the upper surface of the projected portion 7.

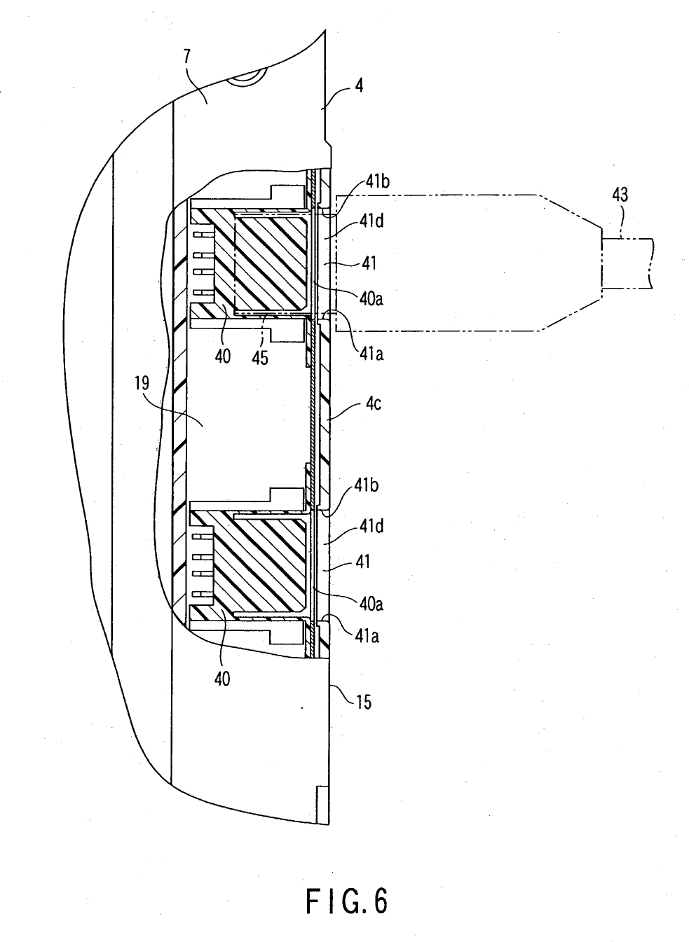

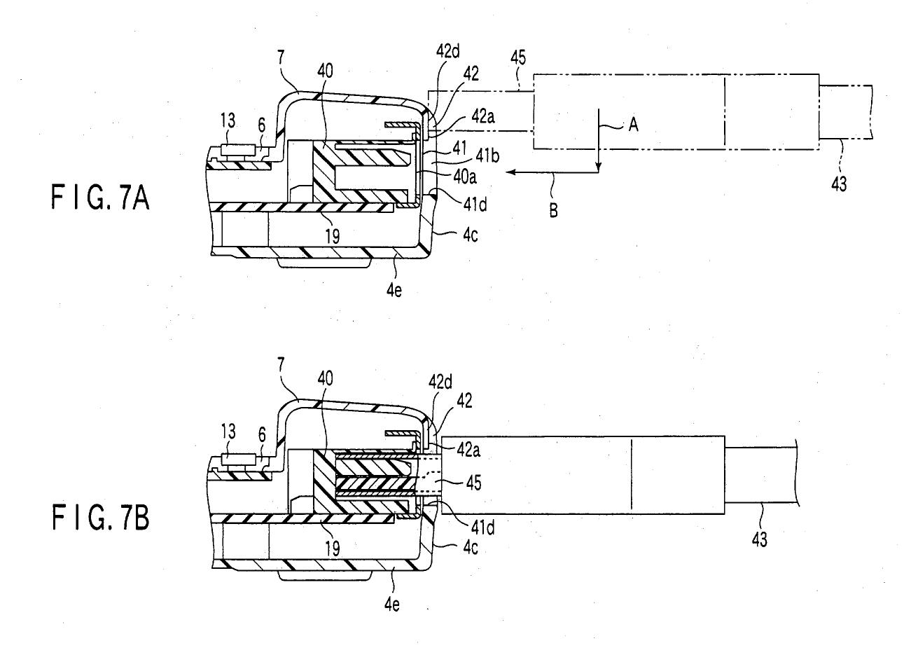

As shown in FIGS. 6 and 7A, the housing 4 contains a printed circuit board 19. The printed circuit board 19 is underneath the keyboard 13 and fixed to the bottom wall 4e of the housing by means of screws. A power supply connector 20, an RGB connector 30, a pair of USB connectors 40 and a LAN connector 50 are mounted on the rear portion of the upper surface of the printed circuit board 19. These connectors 20, 30, 40 and 50 are arranged in the widthwise direction of the housing 4.

As shown in FIG. 2, the rear wall 4c of the housing 4 is provided with first to fourth opening sections 21, 31, 41 and 51. The first opening section 21 contains the power supply connector 20 described above. A plug at the tip end of a power supply cord is detachably connected to the power supply connector 20. The power supply connector 20 is exposed to the outside of the housing 4 through the first opening section 21. The second opening section 31 contains the RGB connector 30 described above. A plug at the tip end of an RGB cable is detachably connected to the RGB connector 30. The RGB connector 30 is exposed to the outside of the housing 4 through the second opening section 31.

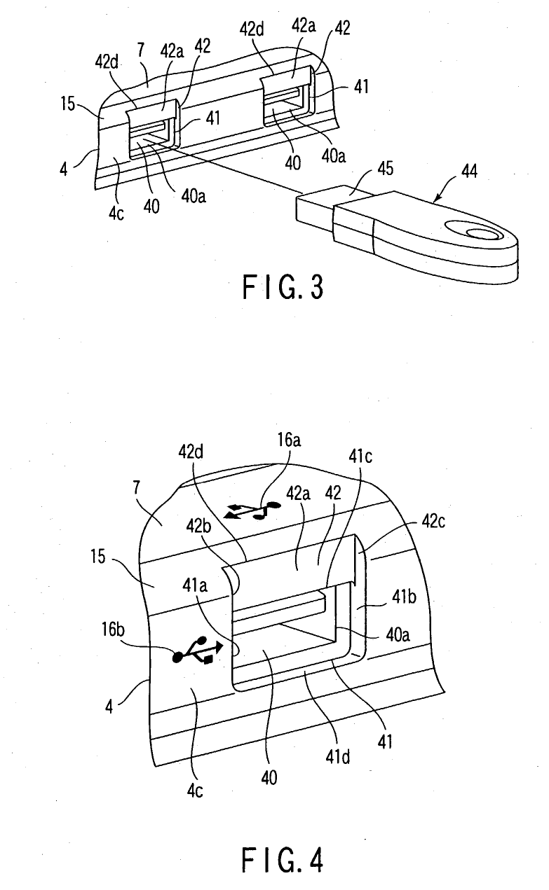

As shown in FIGS. 3 and 4, the third opening sections 41 are provided as a pair and arranged side by side in the widthwise direction of the housing 4. Each third opening section 41 contains one of the USB connectors 40 described above. Each USB connector is provided with a rectangular insertion port 40a. Either a plug 43a at the tip end of a USB cable 43 or a plug 45 at one end of a security key 44 is detachably connected to the insertion port 40a. The insertion port 40a is exposed to the outside of the housing 4 through the third opening section 31.

Each third opening section 41 includes first and second side opening edges 41a and 41b, an upper opening edge 41c and a lower opening edge 41d. The first and second side opening edges 41a and 41b extend in the thickness direction of the housing 4 and are parallel to each other, with a predetermined distance maintained therebetween. The upper opening edge 41c connects the upper ends of the first and second side opening edges 41a and 41b and extends linearly along the upper edge of the insertion port 40a of the USB connector 40. The lower opening edge 41d connects the lower ends of the first and second side opening edges 41a and 41b and extends linearly along the lower edge of the insertion port 40a of the USB connector 40. With this structure, the third opening section 41 has a rectangular opening and has a size corresponding to the insertion port 40a of the USB connector 40.

The rear wall 4c of the housing 4 has a pair of first guide sections 42. Each first guide section 42 is a depressed section having such a size as enables insertion of plug 43a or 45, and is located right above the third opening section. Each first guide section 42 includes a guide surface 42a, a first side edge 42b and a second side edge 42c. The guide surface 42a guides plug 43a or 45 to the third opening section 41 and extends in a direction perpendicular to the thickness direction of the housing 4. The tip end of plug 43a or 45 is brought into slidable contact with the guide surface 42a. The lower portion of the guide surface 42a is continuous with the upper opening edge 41c of the third opening section 41. The guide surface 42a is located inward of the first side opening edge 41a, second side opening edge 41b and lower opening edge 41d of the third opening section. The lower opening edge 41d of the third opening section 41 is located right under the guide surface 42a.

The first and second side edges 42b and 42c of each first guide section 42 extend in the thickness direction of the housing 4. The first side edge 42b is continuous with the upper end of the first opening edge 41a of the third opening section 41. The second side edge 42c is continuous with the upper end of the second side opening edge 41b of the third opening section 41. With this structure, the guide surface 42a is located between the first side edge 42b and the second side edge 42c.

As shown in FIGS. 7A, 7B, 8 and 9, each first guide section 42 has an introducing port 42d in the upper end region thereof. The introducing port 42d is formed in such a manner as to cut out an edge portion 15 defined by the rear wall 4c and the projected portion 7 of the upper wall 4d. With this structure, the first guide section 42 is open upward through the introducing port 42d.

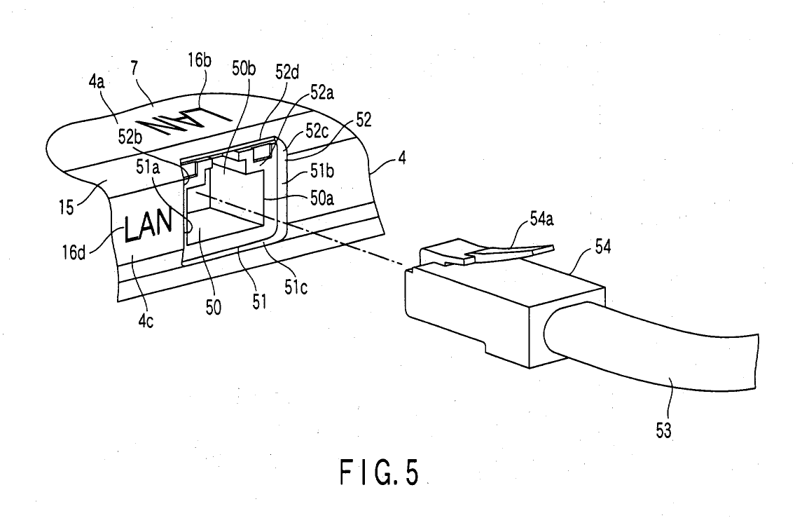

As shown in FIG. 5, the LAN connector 50 includes rectangular insertion port 50a. A plug 54, which is at the tip end of a cable 53 connected to a network line, is detachably inserted into the insertion port 50a. The insertion port 50a of the LAN connector 50 is opposed to the fourth opening section 51 of the rear wall 4c, and is exposed to the outside of the housing 4 through that opening section 51. The LAN connector 50 has an upwardly-projected engagement section 50b in the center of the insertion port 50a. The plug 54 to be inserted into the insertion port 50a is provided with a hook 54a that is brought into detachable engagement with the engagement section 50b. The hook 54a is on the upper surface of the plug 54.

The fourth opening section 51 includes a first side opening edge 51a, a second side opening edge 51b and a lower opening edge 51c. The first and second side opening edges 51a and 51b extend in the thickness direction of the housing 4 and are parallel to each other, with a predetermined distance maintained therebetween. The lower opening edge 51c connects the lower ends of the first and second side opening edges 51a and 51b. The lower opening edge 51c extends linearly along the lower edge of the insertion port 50a of the LAN connector 50.

The rear wall 4c of the housing 4 has a second guide section 52. The second guide section 52 is a depressed section into which the plug 54 is insertable, and is located right above the fourth opening section 51. The second guide section 52 includes a guide surface 52a, a first side edge 52b and a second side edge 52c. The guide surface 52a extends in a direction perpendicular to the thickness direction of the housing 4 and guides the plug 54 into the fourth opening section 51. The tip end of the plug 54 is brought into slidable contact with the guide surface 52a. The lower end of the guide surface 52a is continuous with the fourth opening section 51. The guide surface 52a is located inward of the first side opening edge 51a, second side opening edge 51b and lower opening edge 51c of the fourth opening section 51. The lower opening edge 51c of the fourth opening section 51 is located right under the guide surface 52a.

The first and second side edges 52b and 52c of the second guide section 52 extend in the thickness direction of the housing 4. The first side edge 52b is continuous with the upper end of the first side opening edge 51a of the fourth opening section 51. The second side edge 52c is continuous with the upper end of the second side opening edge 51b of the fourth opening section 51. With this structure, the guide surface 52a is located between the first side edge 52b and the second side edge 52c.

As shown in FIGS. 5, 8 and 9, the second guide section 52 has an introducing port 52d in the upper end region thereof. The introducing port 42d is formed in such a manner as to cut out the edge portion 15 of the housing 4. With this structure, the second guide section 52 is open upward through the introducing port 52d.

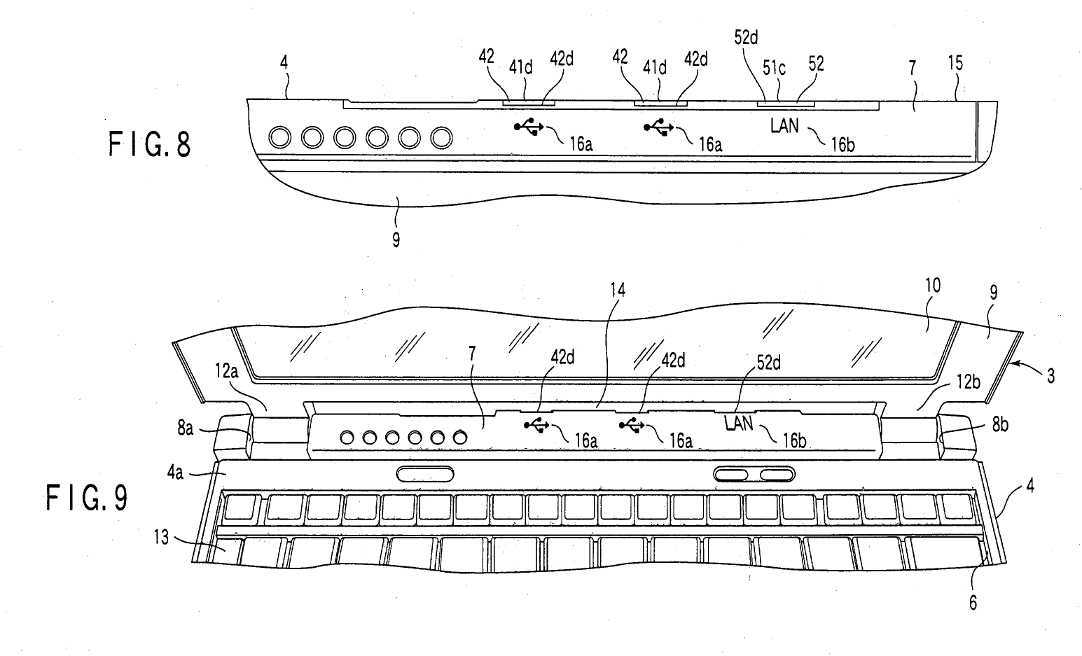

As shown in FIG. 8, the introducing port 42d of the first guide section 42 and the introducing port 52d of the second guide section 52 are seen from a position above the housing 4. They are also seen from a position in front of the housing 4 when the display unit 3 is rotated to the closed position. As shown in FIG. 9, moreover, they are seen in the gap 14 between the display housing 9 and the housing 4 from a position in front of the housing 4 when the display unit 3 is rotated to the open position.

As shown in FIGS. 4, 5, 8 and 9, a plurality of marks 16a, 16b, 16c and 16d are formed on the top surface of the projected portion 7 of the upper wall 4d and on the rear wall 4c of the housing 4. The marks 16a, 16b, 16c and 16d are specifically illustrations or characters and indicate the positions of the USB connectors 40 and the LAN connector 50. Marks 16a and 16b are located immediately in front of the introducing ports 42d and 52d of the first and second guide sections 42 and 52. Marks 16c and 16d are located on one side of the opening sections 41 and 51.

A description will now be given as to how the operator sitting in front of the portable computer 1 connects the plug 45 of the USB cable 43 to the USB connector 40.

First of all, the operator looks at mark 16a on the projected portion 7, thereby visually recognizing the position of the USB connector 40. After confirming the USB connector 40 into which the plug 45 is to be connected, the operator guides the plug 45 into the introducing port 42d of the first guide section 42 and brings the tip end of the plug 45 into contact with the guide surface 42a. In this state, the operator moves the plug 45 downward along the first and second side edges 42b and 42c of the first guide section 42, as indicated by arrow A in FIG. 7A. As a result, the plug 45 slides down the guide surface 42a until the lower surface of the plug 45 comes into contact with the lower opening edge 41d of the third opening section 41. In the state where the lower surface of the plug 45 is in contact with the lower opening edge 41d, the plug 45 is supported by the first side opening edge 41a, the second side opening edge 41b and the lower opening edge 41d and kept opposed to the insertion port 40a of the USB connector 40.

Next, the operator pushes the plug 45 into the insertion port 40a of the USB connector 40 along the lower opening edge 41, as indicated by arrow B in FIG. 7A. As a result, the plug 45 is moved from the third opening section 41 and fitted into the insertion hole 40a of the USB connector 40. In this way, the connection of the plug 45 to the USB connector 40 is completed.

A description will be given as to how the operator sitting in front of the portable computer 1 connects the plug 54 of the cable 53 to the LAN connector 50.

First of all, the operator looks at mark 16b on the projected portion 7, thereby visually recognizing the position of the LAN connector 50. After confirming the LAN connector 50 into which the plug 54 is to be connected, the operator guides the tip end of the plug 54 into the introducing port 52d of the second guide section 52 and brings it into contact with the guide surface 52a. In this state, the operator moves the plug 54 downward along the first and second side edges 52b and 52c of the second guide section 52. As a result, the plug 54 slides down the guide surface 52a until the lower surface of the plug 54 comes into contact with the lower opening edge 51c of the fourth opening section 51. In the state where the lower surface of the plug 54 is in contact with the lower opening edge 51c, the plug 54 is supported by the first side opening edge 51a, the second side opening edge 51b and the lower opening edge 51c and kept opposed to the insertion port 50a of the LAN connector 50.

Next, the operator pushes the plug 54 into the insertion port 50a of the LAN connector 50 along the lower opening edge 51c. As a result, the plug 54 is moved from the fourth opening section 51 and fitted into the insertion hole 50a of the LAN connector 50. In this way, the connection of the plug 54 to the LAN connector 50 is completed.

According to the above-mentioned embodiment of the present invention, the rear wall 4c of the housing 4 is provide with the first and second guide sections 42 and 52, the former 42 being for guiding plug 45 to the USB connector 40 and the latter 52 being for guiding the plug 54 to the LAN connector 50. Although the USB connector 40 and the LAN connector 50 are located at the rear of the housing 4, the operator sitting in front of the portable computer 1 can connect plugs to them easily and reliably.

At the time of connection of the plugs 45 and 54, the operator does not have to lean forward to look at the rear wall 4c of the housing 4. In addition, the operator does not have to visually confirm the positions of the opening sections 41 and 51. Therefore, the plugs 45 and 54 can be connected to the connectors 40 and 50 easily.

Moreover, the introducing ports 42d and 52d in the upper regions of the first and second guide sections 42 and 52 can be recognized by the operator sitting in front of the portable computer 1 without reference to the rotated positions of the display unit 3. In addition, because the marks 16a and 16b indicating the types of the connectors 40 and 50 are shown on the upper surface of the projected portion 7, the operator in front of the portable computer 1 can easily recognize the positions of the connectors 40 and 50 to which the plus 45 and 54 should be inserted.

Accordingly, the plugs 45 and 54 can be quickly guided to the first and second guide sections 42 and 52, and the plugs 45 and 54 are prevented from being inserted to wrong connectors by mistake.

The introducing ports 42d and 52d are open in the edge portion 15 defined by the rear wall 4c and the upper surface of the projected portion 7. With this structure, the plugs 45 and 54 can be positioned relative to the introducing ports 42d and 52d. Therefore, the plus 45 and 54 can be easily guided to the first and second guide sections 42 and 52 by taking hold of them from above.

The first guide section 42 comprises the guide surface 42a with which the tip end of the plug 45 is brought into contact, and the lower opening edge 41d of the third opening section 41 is located right under that guide surface 42d. With this structure, the plug 45 can be positioned relative to the third opening section 41 when the lower surface of the plug 45 has come into contact with the lower opening edge 41d. Accordingly, the plug 45 can be positioned relative to the third opening section 41 with high accuracy.

The guide surface 42a is perpendicular to the housing 4. Therefore, when the plug 45 is moved down along the guide surface 42a, the tip end of the plug 45 can be opposed to the third opening section 41 without being slanted. Hence, the plug 45 is not inserted into the USB connector 40 at an angle thereto, and can be inserted without giving stress to the USB connector 40.

The second guide section 52 is provided with the guide surface 52a with which the tip end of the plug 54 is brought into slidable contact, and the lower opening edge 51c of the fourth opening section 51 is located right under the guide surface 52a. With this structure, the plug 54 can be positioned relative to the fourth opening section 51 when the lower surface of the plug 54 has come into contact with the lower opening edge 51c. Accordingly, the plug 54 can be positioned relative to the fourth opening section 51 with high accuracy.

The guide surface 52a is perpendicular to the housing 4. Therefore, when the plug 54 is moved down along the guide surface 52a, the tip end of the plug 54 can be opposed to the fourth opening section 51 without being slanted. Hence, the plug 54 is not inserted into the USB connector 50 at an angle thereto, and can be inserted without giving stress to the USB connector 50.

The present invention is not limited to the embodiment described above. For example, the guide surfaces of the first and second guide sections need not be vertical. They may be inclined from their upper ends to lower ends toward the interior of the housing.

With this structure, the lower ends of the guide surfaces are close to the insertion ports of the connectors. Hence, plugs can be guided toward the insertion ports of the connectors, while simultaneously positioning the plugs relative to the insertion ports.

In the embodiment described above, the lower opening edges of the third and fourth opening sections are linear. However, it is preferable that the lower opening edges be shaped in accordance with the lower edges of the connectors. For example, if the plugs have a circular cross section, the lower opening edges of the third and fourth opening sections are shaped to be semicircular.

In the embodiment described above, the opening sections through which the connectors are exposed to the outside are formed in the rear wall of the housing. The opening sections need not be formed in the rear wall of the housing; they may be formed in the right and left side walls of the housing. In this case, not only the rear wall but also the side walls constitute peripheral walls of the housing.

The connectors are not limited to USB connectors and LAN connectors. They may be other types of connectors.

The electronic apparatus is not limited to a portable computer that comprises a keyboard and a display unit. For example, it may be a pen-type computer that uses a tablet in place of a keyboard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. Electronic apparatus comprising:
a housing including a peripheral wall having an opening section into which a plug is inserted;
a connector received in the housing, opposed to the opening section and enabling detachable connection to the plug; and
a guide section formed in the peripheral wall and configured to guide the plug to the opening section.

2. Electronic apparatus according to claim 1, wherein the guide section is a depression configured to receive the plug and being adjacent to the opening section.

3. Electronic apparatus according to claim 2, wherein the guide section includes a guide surface with which a tip end of the plug is brought into slidable contact, and the plug is guided to the opening section while being moved along the guide surface.

4. Electronic apparatus according to claim 2, wherein the housing has an upper wall continuous with an upper end of the peripheral wall, and the guide section includes an introducing port formed by cutting out an edge portion defined by the peripheral wall and the upper wall.

5. Electronic apparatus according to claim 4, wherein the upper wall includes a mark which is located at a position corresponding to the introducing port and which indicates a type of the connector.

6. Electronic apparatus according to claim 4, wherein the peripheral wall includes a rear wall located at a rear of the housing, and the guide section is formed in the rear wall.

7. Electronic apparatus according to claim 6, further comprising:
a display unit supported on a rear portion of the housing, the display unit being rotatable between a closed position where the display unit lies and covers the upper wall of the housing from above and an open position where the display unit stands and keeps the upper wall in an exposed state, the display unit and the rear portion of the housing defining a gap when the display unit is rotated to the open position.

8. Electronic apparatus according to claim 7, wherein the introducing port of the guide section is seen through the gap when viewed from a position in front of the housing, when the display unit is rotated to the open position.

9. Electronic apparatus according to claim 1, wherein the connector is a USB connector.

10. Electronic apparatus according to claim 1, wherein the connector is a LAN connector.

11. Electronic apparatus comprising:
a housing including a peripheral wall having an opening section into which a plug is inserted, the opening section including first and second side opening edges which extend in a thickness direction of the housing in parallel to each other, an upper opening edge which connects upper ends of the first and second side opening edges, and a lower opening edge which connects lower ends of the first and second side opening edges;
a connector received in the housing, opposed to the opening section and enabling detachable connection to the plug; and
a depressed section formed in the peripheral wall and configured to guide the plug to the opening section, the depressed section including a first side edge which is continuous with the first side opening edge of the opening section and a second side edge which is continuous with the second side opening edge of the opening section, the depressed section being an upper region of the opening section.

12. Electronic apparatus according to claim 11, wherein the depressed section includes a guide surface with which a tip end of the plug is brought into slidable contact, and the guide surface extends in the thickness direction of the housing and is located inward of the first side opening edge, second side opening edge and lower opening edge of the opening section, the lower opening edge being located right under the guide surface.

13. Electronic apparatus according to claim 11, wherein the connector includes an insertion port into which the plug is insertable, and the opening section corresponds in size to the insertion port.

14. Electronic apparatus comprising:
a housing including a peripheral wall having an opening section into which a plug is inserted;
a connector received in the housing, opposed to the opening section and having an insertion hole into which the plug is detachably connected; and
a guide section formed in the peripheral wall, the guide section being an upper region of the opening section and having a guide surface with which a tip end of the plug is brought into slidable contact, the plug being guided to the opening section while moving along the guide surface.

15. Electronic apparatus according to claim 14, wherein the guide surface extends in the thickness direction of the housing and has a lower end opposed to the opening section.

16. Electronic apparatus according to claim 14, wherein the housing includes an upper wall continuous with an upper end of the peripheral wall, and the upper wall has a mark formed at a position corresponding to the depressed section and indicating a type of the connector.

17. Electronic apparatus comprising:
a housing including a rear wall and an upper wall, the rear wall having an opening section into which a plug is inserted;
a display unit supported on the housing, the display unit being rotatable between a closed position where the display unit lies and covers the upper wall of the housing from above and an open position where the display unit stands and keeps the upper wall in an exposed state;
a connector received in the housing, opposed to the opening section and enabling detachable connection to the plug; and
a guide section formed in the rear wall and configured to guide the plug to the opening section.
